(19) United States
(12) Patent Application Publication
(10) Pub. No.: US 2012/0189534 A1
(43) Pub. Date: Jul. 26, 2012

(54) Method of manufacture of silver oxide nano particles

(76) Inventors: Syed Tajammul Hussain, Islamabad (PK); Mohammad Mazhar, Islamabad (PK)

(21) Appl. No.: 13/013,573

(22) Filed: Jan. 25, 2011

(51) Int. Cl. C01G 5/00; B82Y 40/00

(52) U.S. Cl. 423/604; 977/896

(57) ABSTRACT

Manufacture of silver oxide nano particles is disclosed comprising using Armine-z as desegregating agent for silver salt solution and precipitating it with sodium hydroxide.

### FIELD OF INVENTION

This invention relates primarily to a novel process for the manufacture of silver oxide nano materials as highly effective and useful antibacterial agents, styptic agents in the treatment of wounds, crop and food protection and other similar applications.

### BACKGROUND AND PRIOR ART

It is known in the art that silver element exhibits germicidal properties and for this reason, it has been widely used as a germicidal agent long before the modern antibiotics were discovered. In the past centuries, users added silver particles into the drinking water, or submerged intact silver pieces in the drinking water for the purpose of consuming the assumed dissolved silver. It seems plausible that the use of silverware for cooking, storage and eating food may have been prompted by the belief in the highly potent healing properties of silver in curing disease without any discernable side effects.

Since the biological properties of silver are dependent on the contact between silver metal and the biological tissues, several attempts have been made to enhance the activity of silver by using it in a finer state of dispersion. A large volume of prior art exists on the use of silver in a variety of applications, including the use of fine silver particles called nano particles. Since the preparation of nano silver particles requires a fine balance of several physicochemical factors, many of which are unpredictable, a large volume of prior art exists on the methods to prepare silver nano particles. Given below is a review of some important prior art in this field of manufacture of nano silver particles and their use.

Korean Patent WO200703256 (Shin Hyunkyung et al.) discloses a method for the manufacturing of silver which includes the formation of silver nano particles by the specified droplet of its solution.

European Patent WO 2005/120173 A₃ (Paknikar Kishore, et al.) describe the antimicrobial activity of biological stabilized silver nano particles, with an average size of 1-100 nm on a carrier in which the concentration of these particles is 1 to 6 ppm.

Korean Patent KR 20040097976 (Jang Take Soo et al.) describes a method which comprises spraying or coating a liquid containing a photo catalyst or silver nano particles on to a target product having antimicrobial and deodorizing capabilities in the course of production of target product.

Korean Patent KR 20040107187 (Hwang Seung Jin et al.) describes a process for the production of colloidal silver particles by forming a uniform electric field between the anode and the cathode, thereby performing ionization of silver.

Korean Patent KR20040104277 (Choi Heui Kyo et al.) describe a nano silver application by describing an absorbent layer for diaper which lessens odor and cleanses genital or gans.

Korean Patent KR20040103200 (Son Hang Ho et al.) describes a method to coat ceramic surfaces with silver nano particles for antimicrobial and antifungal actions. This method comprises the step of preparing a thermosetting resin mixture by injecting 30-50 ppm of antimicrobial nano particles with 5-10 nm into a resin containing 70-85 wt % of a thermosetting resin, 10-15 wt % of an organic binder, 2-3 wt % softener, 0.5-1.0 wt % of a hardener, and 0.01-0.5 wt % of a pigment coating the ceramic with thermosetting resin mixture.

Korean Patent 20040047154 (Jung Geyong Yeol et al.) discloses a method for the production of spherical silver particles by preparing a nickel-precursors by dissolving a nickel compound selected from nickel nitrate, nickel acetate, nickel chloride, nickel hydrate and nickel sulfate by injecting the nickel precursor into a droplet sprayer and drying and pyrolyzing the generated droplets in the reactor temperature range of 500-1500° C.

Korean Patent KR20050016260 (Lee Sung Hwa et al.) describes the use of silver nano particles for promoting health by dispersing them on the wool for antibacterial, and sterilizing properties.

Koraen Patent KR20050023114 (Choi Kyu Man et al.) describes an application of silver nano particles in paint industries and wall paper industries by dispersing these particles in paint and applying a very thin coating on wall papers.

European Patent GB425779 (Johnson Loyal et al.) teaches a method for the manufacturing of silver nano particles which comprises the production of silver nano particles by vaporizing the salt solution at high temperature and controlling the size by the flow of gas inside the furnace.

Korean patent KR20010069645 (Kim Yeong Gon et al.) describe the use of silver nano particles in water sterilizing technology by dispersing the silver nano particles on silica, rock, zeolite particles.

Taiwan patent TW265024Y (Hung Li Ying et al.) describe the use of silver nano particles as a hygiene absorbent.

Chinese Patent CN1727381 (Chen Rulin et al.) describes the use of silver nano particles by preparing the silver latex or coating the lubricant by silver particles for killing bacteria.

U.S. patent application US2005183543 (Sasaki Takuya et al.) describes a method for the production of silver nano powder by dissolving the silver powder into dispersing medium and than reacting the silver powder with the neutralizing and then exposing the silver oxide particles to ultraviolet light rays to reduce the same to fine silver particles.
Abid J P, Wark A W, Brevet P F, Girault H H. Preparation of silver nanoparticles in solution from a silver salt by laser irradiation. Chem Commun (Camb). 2002 April 7; (7):792-3.
Ahmed I, Ready D, Wilson M, Knowles J C. Antimicrobial effect of silver-doped phosphate-based glasses. J Biomed Mater Res A. 2006 Dec. 1; 79(3):618-26.
Aizawa M, Cooper A M, Malac M, Buriak J M. Silver nano-inukshuks on germanium. Nano Lett. 2005 May; 5(5):815-9.
Anand M, Bell P W, Fan X, Enick R M, Roberts C B. Synthesis and steric stabilization of silver nanoparticles in neat carbon dioxide solvent using fluorine-free compounds. J Phys Chem B. 2006 Aug. 3; 110(30):14693-701.
Ankamwar B, Damle C, Ahmad A, Sastry M. Biosynthesis of gold and silver nanoparticles using Emblica Officinalis fruit extract, their phase transfer and transmetallation in an organic solution. J Nanosci Nanotechnol. 2005 October; 5(10):1665-71.
Aslan K, Zhang J, Lakowicz J R, Geddes C D. Saccharide sensing using gold and silver nanoparticles—a review. J Fluoresc. 2004 July; 14(4):391-400. Review.
Baker C, Pradhan A, Pakstis L, Pochan D J, Shah S I. Synthesis and antibacterial properties of silver nanoparticles. J Nanosci Nanotechnol. 2005 February; 5(2):244-9.
Bhainsa K C, D'Souza S F. Extracellular biosynthesis of silver nanoparticles using the fungus Aspergillus fumigatus. Colloids Surf B Biointerfaces. 2006 Feb. 1; 47(2):160-4.
Bhattacharya S, Das A K, Banerjee A, Chakravorty D. Dendron-like growth of silver nanoparticles using a water-soluble oligopeptide. J Phys Chem B. 2006 Jun. 8; 110(22):10757-61.
Bozanic D K, Djokovic V, Blanusa J, Nair P S, Georges M K, Radhakrishnan T. Preparation and properties of nano-sized Ag and Ag2S particles in biopolymer matrix. Eur Phys J E Soft Matter. 2007 January; 22(1):51-9.
Bugla-Ploskonska G, Leszkiewicz A, Borak B, Jasiorski M, Drulis-Kawa Z, Baszczuk A, Maruszewski K, Doroszkiewicz W. Bactericidal properties of silica particles with silver islands located on the surface. Int J Antimicrob Agents. 2007 June; 29(6):746-8.
Chandran S P, Chaudhary M, Pasricha R, Ahmad A, Sastry M. Synthesis of gold nanotriangles and silver nanoparticles using Aloe vera plant extract. Biotechnol Prog. 2006 March-April; 22(2):577-83.
Chang G, Zhang J, Oyama M, Hirao K. Silver-nanoparticle-attached indium tin oxide surfaces fabricated by a seed-mediated growth approach. J Phys Chem B. 2005 Jan. 27; 109(3):1204-9.
Chen H, Wang Y, Dong S, Wang E. An approach for fabricating self-assembled monolayer of Ag nanoparticles on gold as the SERS-active substrate. Spectrochim Acta A Mol Biomol Spectrosc. 2006 May 15; 64(2):343-8.
Chen W, Liu Y, Courtney H S, Bettenga M, Agrawal C M, Bumgardner J D, Ong J L. In vitro anti-bacterial and biological properties of magnetron co-sputtered silver-containing hydroxyapatite coating. Biomaterials. 2006 November; 27(32):5512-7.
Cioffi N, Ditaranto N, Torsi L, Picca R A, De Giglio E, Sabbatini L, Novello L, Tantillo G, Bleve-Zacheo T, Zambonin P G. Synthesis, analytical characterization and bioactivity of Ag and Cu nanoparticles embedded in poly-vinyl-methyl-ketone films. Anal Bioanal Chem. 2005 August; 382(8):1912-8.
Colmano G, Edwards S S, Barranco S D. Activation of antibacterial silver coatings on surgical implants by direct current: preliminary studies in rabbits. Am J Vet Res. 1980 June; 41(6):964-6.
Dai L L, Sharma R, Wu C Y. Self-assembled structure of nanoparticles at a liquid-liquid interface. Langmuir. 2005 Mar. 29; 21(7):2641-3.
Dobbs W, Suisse J M, Douce L, Welter R. Electrodeposition of silver particles and gold nanoparticles from ionic liquid-crystal precursors. Angew Chem Int Ed Engl. 2006 Jun. 19; 45(25):4179-82.
Dryfe R A, Walter E C, Penner R M. Electrodeposition of metal nanostructures by galvanic displacement powered with insoluble crystals of a ferrocene derivative. Chemphyschem. 2004 Dec. 10; 5(12):1879-84.
El-Hayek R F, Dye K, Warner J C. Bacteriostatic polymer film immobilization. J Biomed Mater Res A. 2006 Dec. 15; 79(4):874-81.
Eustis S, Krylova G, Eremenko A, Smirnova N, Schill A W, El-Sayed M. Growth and fragmentation of silver nanoparticles in their synthesis with a fs laser and CW light by photo-sensitization with benzophenone. Photochem Photobiol Sci. 2005 January; 4(1):154-9.
Feng Q L, Wu J, Chen G Q, Cui F Z, Kim T N, Kim J O. A mechanistic study of the antibacterial effect of silver ions on Escherichia coli and Staphylococcus aureus. J Biomed Mater Res. 2000 Dec. 15; 52(4):662-8.
Fernandez C A, Wai C M. Continuous tuning of silver nanoparticle size in a water-insupercritical carbon dioxide microemulsion. Small. 2006 November; 2(11):1266-9.
FISCHER M. [Present view point on bacterial effect of silver.] Zentralbl Bakteriol [Orig]. 1957 November; 170(1-5):199-206.
Fu J, Ji J, Fan D, Shen J. Construction of antibacterial multilayer films containing nano-silver via layer-by-layer assembly of heparin and chitosan-silver ions complex. J Biomed Mater Res A. 2006 Dec. 1; 79(3):665-74.
Furno F, Morley K S, Wong B, Sharp B L, Arnold P L, Howdle S M, Bayston R, Brown P D, Winship P D, Reid H J. Silver nanoparticles and polymeric medical devices: a new approach to prevention of infection? J Antimicrob Chemother. 2004 December; 54(6):1019-24.
Fuster G, Tyler J M, Brener N E, Callaway J, Bagayoko D. Electronic structure and related properties of silver. Phys Rev B Condens Matter. 1990 Oct. 15; 42(12):7322-7329.
Gao J, Fu J, Lin C, Lin J, Han Y, Yu X, Pan C. Formation and photoluminescence of silver nanoparticles stabilized by a two-armed polymer with a crown ether core. Langmuir. 2004 Oct. 26; 20(22):9775-9.
Goldbert A A, Shapero M, Wilder E. Antibacterial colloidal electrolytes; the potentiation of the activities of mercuric-, phenylmercuric- and silver ions by a colloidal sulphonic anion. J Pharm Pharmacol. 1950 January; 2(1):20-6.
Gray J E, Norton P R, Alnouno R, Marolda C L, Valvano M A, Griffiths K. Biological efficacy of electroless-deposited silver on plasma activated polyurethane. Biomaterials. 2003 July; 24(16):2759-65.
Guggenbichler J P, Boswald M, Lugauer S, Krall T. A new technology of microdispersed silver in polyurethane induces antimicrobial activity in central venous catheters. Infection. 1999; 27 Suppl 1:S16-23.
Gupta A, Maynes M, Silver S. Effects of halides on plasmid-mediated silver resistance in Escherichia coli. Appl Environ Microbiol. 1998 December; 64(12):5042-5.
Hall R E, Bender G, Marquis R E. Inhibitory and cidal antimicrobial actions of electrically generated silver ions. J Oral Maxillofac Surg. 1987 September; 45(9):779-84.
Hao E, Schatz G C, Hupp J T. Synthesis and optical properties of anisotropic metal nanoparticles. J Fluoresc. 2004 July; 14(4):331-41.
Hipler U C, Elsner P, Fluhr J W. Antifungal and antibacterial properties of a silver-loaded cellulosic fiber. J Biomed Mater Res B Appl Biomater. 2006 April; 77(1):156-63.
Huang L, Li D Q, Lin Y J, Wei M, Evans D G, Duan X. Controllable preparation of Nano-MgO and investigation of its bactericidal properties. J Inorg Biochem. 2005 May; 99(5):986-93.
Jeon H J, Yi S C, Oh S G. Preparation and antibacterial effects of Ag—SiO2 thin films by sol-gel method. Biomaterials. 2003 December; 24(27):4921-8.
Jia H, Xu W, An J, Li D, Zhao B. A simple method to synthesize triangular silver nanoparticles by light irradiation. Spectrochim Acta A Mol Biomol Spectrosc. 2006 July; 64(4):956-60.
Jiang X, Zeng Q, Yu A. Thiol-frozen shape evolution of triangular silver nanoplates. Langmuir. 2007 Feb. 13; 23(4):2218-23.
Jiang Z, Yuan W, Pan H. Luminescence effect of silver nanoparticle in water phase. Spectrochim Acta A Mol Biomol Spectrosc. 2005 September; 61(11-12):2488-94.
Jiang Z J, Liu C Y, Sun L W. Catalytic properties of silver nanoparticles supported on silica spheres. J Phys Chem B. 2005 Feb. 10; 109(5):1730-5.
Jin R, Jureller J E, Kim H Y, Scherer N F. Correlating second harmonic optical responses of single Ag nanoparticles with morphology. J Am Chem Soc. 2005 Sep. 14; 127(36):12482-3.
Kariuki N N, Luo J, Maye M M, Hassan S A, Menard T, Naslund H R, Lin Y, Wang C, Engelhard M H, Zhong C J. Composition-controlled synthesis of bimetallic gold-silver nanoparticles. Langmuir. 2004 Dec. 7; 20(25):11240-6.
Kawashita M, Toda S, Kim H M, Kokubo T, Masuda N. Preparation of antibacterial silver-doped silica glass microspheres. J Biomed Mater Res A. 2003 Aug. 1; 66(2):266-74.
Keki S, Torok J, Deak G, Daroczi L, Zsuga M. Silver Nanoparticles by PAMAM-Assisted Photochemical Reduction of Ag(+). J Colloid Interface Sci. 2000 Sep. 15; 229(2):550-553.
Kim J, Cho M, Oh B, Choi S, Yoon J. Control of bacterial growth in water using synthesized inorganic disinfectant. Chemosphere. 2004 May; 55(5):775-80.
Kim J S, Kuk E, Yu K N, Kim J H, Park S J, Lee H J, Kim S H, Park Y K, Park Y H, Hwang C Y, Kim Y K, Lee Y S, Jeong D H, Cho M H. Antimicrobial effects of silver nanoparticles. Nanomedicine. 2007 March; 3(1):95-101.
Kitamura H, Kondo Y, Sakairi N, Nishi N. Preparation and characterization of antibacterial alginate film containing DNA as a carrier of silver ion. Nucleic Acids Symp Ser. 1997; (37):273-4.
Klaus T, Joerger R, Olsson E, Granqvist C G. Silver-based crystalline nanoparticles, microbially fabricated. Proc Natl Acad Sci USA. 1999 Nov. 23; 96(24):13611-4.
Konno T J, Okunishi E, Ohsuna T, Hiraga K. HAADF-STEM study on the early stage of precipitation in aged Al—Ag alloys. J Electron Microsc (Tokyo). 2004; 53(6):611-6.
Kramer R M, Li C, Carter D C, Stone M O, Naik R R. Engineered protein cages for nanomaterial synthesis. J Am Chem Soc. 2004 Oct. 20; 126(41):13282-6.
Kumar R, Munstedt H. Silver ion release from antimicrobial polyamide/silver composites. Biomaterials. 2005 May; 26(14):2081-8.
Lee D, Cohen R E, Rubner M F. Antibacterial properties of Ag nanoparticle loaded multilayers and formation of magnetically directed antibacterial microparticles. Langmuir. 2005 Oct. 11; 21(21):9651-9.
Lee H Y, Park H K, Lee Y M, Kim K, Park S B. A practical procedure for producing silver nanocoated fabric and its antibacterial evaluation for biomedical applications. Chem Commun (Camb). 2007 Jul. 28; (28):2959-61.
Lee S J, Han S W, Kim K. Perfluorocarbon-stabilized silver nanoparticles manufactured from layered silver carboxylates. Chem Commun (Camb). 2002 March 7; (5):442-3.
Lenoir S, Pagnoulle C, Galleni M, Compere P, Jerome R, Detrembleur C. Polyolefin matrixes with permanent antibacterial activity: preparation, antibacterial activity, and action mode of the active species. Biomacromolecules. 2006 August; 7(8):2291-6.
Lesniak W, Bielinska A U, Sun K, Janczak K W, Shi X, Baker J R Jr, Balogh L P. Silver/dendrimer nanocomposites as biomarkers: fabrication, characterization, in vitro toxicity, and intracellular detection. Nano Lett. 2005 November; 5(11):2123-30.
Li C, Fang G, Ren Y, Fu Q, Zhao X. Silver nanoisland induced synthesis of ZnO nanostructures by vapor phase transport. J Nanosci Nanotechnol. 2006 May; 6(5):1467-73.
Li C M, Robertson 1M, Jenkins M L, Hutchison J L, Doole R C. In situ TEM observation of the nucleation and growth of silver oxide nanoparticles. Micron. 2005; 36(1):9-15.
Li H, Cullum B M. Dual layer and multilayer enhancements from silver film over nanostructured surface-enhanced Raman substrates. Appl Spectrosc. 2005 April; 59(4):410-7.
Li Y, Leung P, Yao L, Song Q W, Newton E. Antimicrobial effect of surgical masks coated with nanoparticles. J Hosp Infect. 2006 January; 62(1):58-63.
Li Z, Lee D, Sheng X, Cohen R E, Rubner M F. Two-level antibacterial coating with both release-killing and contact-killing capabilities. Langmuir. 2006 Nov. 21; 22(24):9820-3.
Lin B, Dong J, Whitcomb D R, McCormick A V, Davis H T. Crystallization of silver stearate from sodium stearate dispersions. Langmuir. 2004 Oct. 12; 20(21):9069-74.
Liu J, Raveendran P, Shervani Z, Ikushima Y, Hakuta Y. Synthesis of Ag and AgI quantum dots in AOT-stabilized water-in-CO2 microemulsions. Chemistry. 2005 Mar. 4; 11(6):1854-60.
Lok C N, Ho C M, Chen R, He Q Y, Yu W Y, Sun H, Tam P K, Chiu J F, Che C M. Proteomic analysis of the mode of antibacterial action of silver nanoparticles. J Proteome Res. 2006 April; 5(4):916-24.
Lok C N, Ho C M, Chen R, He Q Y, Yu W Y, Sun H, Tam P K, Chiu J F, Che C M. Silver nanoparticles: partial oxidation and antibacterial activities. J Biol Inorg Chem. 2007 May; 12(4):527-34.
Lu L, Kobayashi A, Kikkawa Y, Tawa K, Ozaki Y. Oriented attachment-based assembly of dendritic silver nanostructures at room temperature. J Phys Chem B. 2006 Nov. 23; 110(46):23234-41.
Luo C, Zhang Y, Zeng X, Zeng Y, Wang Y. The role of poly(ethylene glycol) in the formation of silver nanoparticles. J Colloid Interface Sci. 2005 Aug. 15; 288(2):444-8.
Machulek Junior A, de Oliveira H P, Gehlen M H. Preparation of silver nanoprisms using poly(N-vinyl-2-pyrrolidone) as a colloid-stabilizing agent and the effect of silver nanoparticles on the photophysical properties of cationic dyes. Photochem Photobiol Sci. 2003 September; 2(9):921-5.
Marini M, De Niederhausern S, Iseppi R, Bondi M, Sabia C, Toselli M, Pilati F. Antibacterial activity of plastics coated with silver-doped organic-inorganic hybrid coatings prepared by sol-gel processes. Biomacromolecules. 2007 April; 8(4):1246-54.
Melaiye A, Sun Z, Hindi K, Milsted A, Ely D, Reneker D H, Tessier C A, Youngs W J. Silver(I)-imidazole cyclophane gem-diol complexes encapsulated by electrospun tecophilic nanofibers: formation of nanosilver particles and antimicrobial activity. J Am Chem Soc. 2005 Feb. 23; 127(7):2285-91.
Morones J R, Frey W. Environmentally sensitive silver nanoparticles of controlled size synthesized with PNIPAM as a nucleating and capping agent. Langmuir. 2007 Jul. 17; 23(15):8180-6.
Nishioka M, Nishimura T, Ookubo A, Taya M. Improved bactericidal activity of silver-loaded zirconium phosphate in the presence of Cl— by combining with hydroxyapatite. Biotechnol Lett. 2003 August; 25(15):1263-6.
Panacek A, Kvitek L, Prucek R, Kolar M, Vecerova R, Pizurova N, Sharma V K, Nevecna T, Zboril R. Silver colloid nanoparticles: synthesis, characterization, and their antibacterial activity. J Phys Chem B. 2006 Aug. 24; 110(33):16248-53.
Park S J, Jang Y S. Preparation and characterization of activated carbon fibers supported with silver metal for antibacterial behavior. J Colloid Interface Sci. 2003 May 15; 261(2):238-43.
Park S J, Kim B J. A study on NO removal of activated carbon fibers with deposited silver nanoparticles. J Colloid Interface Sci. 2005 Feb. 1; 282(1):124-7.
Prochazka M, Vlckova B, Stepanek J, Turpin P Y. Probing of porphyrin surface chemistry in systems with laser-ablated Ag nanoparticle hydrosol: role of thiosulfate anions. Langmuir. 2005 Mar. 29; 21(7):2956-62.
Qu L, Luo P G, Taylor S, Lin Y, Huang W, Anyadike N, Tzeng T R, Stutzenberger F, Latour R A, Sun Y P. Visualizing adhesion-induced agglutination of Escherichia coli with mannosylated nanoparticles. J Nanosci Nanotechnol. 2005 February; 5(2):319-22.
Rameshbabu N, Sampath Kumar T S, Prabhakar T G, Sastry V S, Murty K V, Prasad Rao K. Antibacterial nanosized silver substituted hydroxyapatite: synthesis and characterization. J Biomed Mater Res A. 2007 Mar. 1; 80(3):581-91.
Raveendran P, Fu J, Wallen S L. Completely “green” synthesis and stabilization of metal nanoparticles. J Am Chem Soc. 2003 Nov. 19; 125(46):13940-1.
Ray S, Das A K, Banerjee A. Smart oligopeptide gels: in situ formation and stabilization of gold and silver nanoparticles within supramolecular organogel networks. Chem Commun (Camb). 2006 July 14; (26):2816-8.
Ren X, Meng X, Chen D, Tang F, Jiao J. Using silver nanoparticle to enhance current response of biosensor. Biosens Bioelectron. 2005 Sep. 15; 21(3):433-7.
Rocha T C, Zanchet D. Growth aspects of photochemically synthesized silver triangular nanoplates. J Nanosci Nanotechnol. 2007 February; 7(2):618-25.
SANDUSKY WR. Antibacterial agents in surgery. J Natl Med Assoc. 1951 May; 43(3):169-74.
Sant S B, Gill K S, Burrell R E. Nanostructure, dissolution and morphology characteristics of microcidal silver films deposited by magnetron sputtering. Acta Biomater. 2007 May; 3(3):341-50.
Sarkar A, Kapoor S, Mukherjee T. Preparation, characterization, and surface modification of silver nanoparticles in formamide. J Phys Chem B. 2005 Apr. 28; 109(16):7698-704.
Savluk O S, Terletskaia A V, Potapchenko N G. [Selection of nutritional media for studying the anti-microbial action of silver ions on Escherichia coli] Mikrobiol Zh. 1984 November-December; 46(6):72-4.
See K C, Spicer J B, Brupbacher J, Zhang D, Vargo T G. Modeling interband transitions in silver nanoparticle-fluoropolymer composites. J Phys Chem B. 2005 Feb. 24; 109(7):2693-8.
Selvakannan P R, Swami A, Srisathiyanarayanan D, Shirude P S, Pasricha R, Mandale A B, Sastry M. Synthesis of aqueous Au core-Ag shell nanoparticles using tyrosine as a pH-dependent reducing agent and assembling phase-transferred silver nanoparticles at the air-water interface. Langmuir. 2004 Aug. 31; 20(18):7825-36.
Sendova M, Sendova-Vassileva M, Pivin J C, Hofmeister H, Coffey K, Warren A. Experimental study of interaction of laser radiation with silver nanoparticles in SiO2 matrix. J Nanosci Nanotechnol. 2006 March; 6(3):748-55.
Shahverdi A R, Fakhimi A, Shahverdi H R, Minaian S. Synthesis and effect of silver nanoparticles on the antibacterial activity of different antibiotics against Staphylococcus aureus and Escherichia coli. Nanomedicine. 2007 June; 3(2):168-71.
Sharma J, Vivek J P, Vijayamohanan K P. Electron transfer behavior of monolayer protected nanoclusters and nanowires of silver and gold. J Nanosci Nanotechnol. 2006 November; 6(11):3464-9.
She W J, Zhang F Q. [Comparison of the antibacterial activity on oral pathogens among six types of nano-silver base inorganic antibacterial agents] Shanghai Kou Qiang Yi Xue. 2003 October; 12(5):356-8.
Shemer G, Krichevski O, Markovich G, Molotsky T, Lubitz I, Kotlyar A B. Chirality of silver nanoparticles synthesized on DNA. J Am Chem Soc. 2006 Aug. 30; 128(34):11006-7.
Shi Z, Neoh K G, Kang E T. Surface-grafted viologen for precipitation of silver nanoparticles and their combined bactericidal activities. Langmuir. 2004 Aug. 3; 20(16):6847-52.
Shin H S, Yang H J, Kim S B, Lee M S. Mechanism of growth of colloidal silver nanoparticles stabilized by polyvinyl pyrrolidone in gamma-irradiated silver nitrate solution. J Colloid Interface Sci. 2004 Jun. 1; 274(1):89-94.
Smetana A B, Klabunde K J, Sorensen C M, Ponce A A, Mwale B. Low-temperature metallic alloying of copper and silver nanoparticles with gold nanoparticles through digestive ripening. J Phys Chem B. 2006 Feb. 9; 110(5):2155-8.
Sondi I, Salopek-Sondi B. Silver nanoparticles as antimicrobial agent: a case study on E. coli as a model for Gram-negative bacteria. J Colloid Interface Sci. 2004 Jul. 1; 275(1):177-82.
Sun J, Ma D, Zhang H, Liu X, Han X, Bao X, Weinberg G, Pfander N, Su D. Toward monodispersed silver nanoparticles with unusual thermal stability. J Am Chem Soc. 2006 Dec. 13; 128(49):15756-64.
Sun X, Li Y. Ag+C core/shell structured nanoparticles: controlled synthesis, characterization, and assembly. Langmuir. 2005 Jun. 21; 21(13):6019-24.
Taylor P L, Omotoso O, Wiskel J B, Mitlin D, Burrell R E. Impact of heat on nanocrystalline silver dressings. Part II: Physical properties. Biomaterials. 2005 December; 26(35):7230-40.
Thiel J, Pakstis L, Buzby S, Raffi M, Ni C, Pochan D J, Shah S I. Antibacterial properties of silver-doped titania. Small. 2007 May; 3(5):799-803.
Tom R T, Suryanarayanan V, Reddy P G, Baskaran S, Pradeep T. Ciprofloxacin-protected gold nanoparticles. Langmuir. 2004 Mar. 2; 20(5):1909-14.
Tong M C, Chen W, Sun J, Ghosh D, Chen S. Dithiocarbamate-capped silver nanoparticles. J Phys Chem B. 2006 Oct. 5; 110(39):19238-42.
Ullah M H, Ha C S. Size-controlled synthesis and optical properties of doped nanoparticles prepared by soft solution processing. J Nanosci Nanotechnol. 2005 September; 5(9):1376-94.
Ullman E, Moser B. Influence of polyoxyethylene adducts on the antibacterial activity of antibiotics. 4. On the importance of surface-active substances in the production of drug preparations. Arch Pharm. 1962 February; 295:136-43.
Vigneshwaran N, Kathe A A, Varadarajan P V, Nachane R P, Balasubramanya R H. Functional finishing of cotton fabrics using silver nanoparticles. J Nanosci Nanotechnol. 2007 June; 7(6): 1893-7.
Vigneshwaran N, Nachane R P, Balasubramanya R H, Varadarajan P V. A novel one-pot ‘green’ synthesis of stable silver nanoparticles using soluble starch. Carbohydr Res. 2006 Sep. 4; 341(12):2012-8.
Wallace J M, Dening B M, Eden K B, Stroud R M, Long J W, Rolison D R. Silver-colloidnucleated cytochrome c superstructures encapsulated in silica nanoarchitectures. Langmuir. 2004 Oct. 12; 20(21):9276-81.
Wang X, Li Y. Rare-Earth-compound nanowires, nanotubes, and fullerene-like nanoparticles: synthesis, characterization, and properties. Chemistry. 2003 Nov. 21; 9(22):5627-35.
Wang Y, Li M, Jia H, Song W, Han X, Zhang J, Yang B, Xu W, Zhao B. Optical properties of Ag/CdTe nanocomposite self-organized by electrostatic interaction. Spectrochim Acta A Mol Biomol Spectrosc. 2006 May 1; 64(1):101-5.
Wei G, Zhou H, Liu Z, Song Y, Wang L, Sun L, Li Z. One-step synthesis of silver nanoparticles, nanorods, and nanowires on the surface of DNA network. J Phys Chem B. 2005 May 12; 109(18):8738-43.
Wiley B, Sun Y, Mayers B, Xia Y. Shape-controlled synthesis of metal nanostructures: the case of silver. Chemistry. 2005 Jan. 7; 11(2):454-63.
Xu R, Wang D, Zhang J, Li Y. Shape-dependent catalytic activity of silver nanoparticles for the oxidation of styrene. Chem Asian J. 2006 Dec. 18; 1(6):888-93.
Yang C C, Wan C C, Wang Y Y. Synthesis of Ag/Pd nanoparticles via reactive micelles as templates and its application to electroless copper deposition. J Colloid Interface Sci. 2004 Nov. 15; 279(2):433-9.
Yoon K Y, Hoon Byeon J, Park J H, Hwang J. Susceptibility constants of Escherichia coli and Bacillus subtilis to silver and copper nanoparticles. Sci Total Environ. 2007 Feb. 15; 373(2-3):572-5.
Zhai H J, Sun D W, Wang H S. Catalytic properties of silica/silver nanocomposites. J Nanosci Nanotechnol. 2006 July; 6(7):1968-72.
Zhang L, Shen Y, Xie A, Li S, Jin B, Zhang Q. One-step synthesis of monodisperse silver nanoparticles beneath vitamin E Langmuir monolayers. J Phys Chem B. 2006 Apr. 6; 110(13):6615-20.
Zhang Y, Chen F, Zhuang J, Tang Y, Wang D, Wang Y, Dong A, Ren N. Synthesis of silver nanoparticles via electrochemical reduction on compact zeolite film modified electrodes. Chem Commun (Camb). 2002 December 7; (23):2814-5.
Zhang Y Y, Sun J. A study on the bio-safety for nano-silver as anti-bacterial materials Zhongguo Yi Liao Qi Xie Za Zhi. 2007 January; 31(1):36-8, 16.
Zhao B, Wang B, Zhao Y, Zhang S, Sakairi N, Nishi N. DNA-collagen complex as a carrier for Ag+ delivery. Int J Biol Macromol. 2005 Nov. 15; 37(3):143-7.

The prior art cited above relates to the method of production of silver oxide nano particles; these are however complex and expensive, requiring high temperature treatment. There remains therefore a need to invent a simpler and cheaper method to allow wide use of nano oxide silver particles in the field of healthcare.

The present invention describes a simple method for the production of silver oxide nano particles and their applications ranging from their use as antibacterial, in water sterilization, in hemorrhage control, and in a variety of agricultural uses.

### DETAILED DESCRIPTION OF INVENTION

Silver metal dispensed as a suspension or as gel in water is highly beneficial in treating many conditions in humans and animals. When prolonged contact is established, for example in the application of silver gels or solutions, silver nano particles can inhibit the growth or eradicate bacteria, virus, and other pathogenic organism. The silver gel and silver solution composition can also have anti-inflammatory effects, sufficient to reduce or stop, for example swelling, excessive bleeding, burn complications and certain symptoms of asthma.

In the present invention is described a process for the preparation of silver oxide nano particles wherein the majority of particles in the size range of 10-15 nanometers in diameter are prepared by a process of controlled precipitation of a silver salt such as silver nitrate hexahydrate using sodium hydroxide as the precipitating agent in the presence of a surfactant such as Armine-Z to act as a desegregating agent. The precipitating agent such as sodium hydroxide is used at a concentration of 5% w/v, the surfactant at 0.01-1% w/v and the silver salt solution, generally at a concentration of about 5% w/v. In a typical preparative step, the distribution of the particle size obtained is given in Table 1.

TABLE 1
Typical particle size distribution of silver oxide

| Particle Size | Frequency |
|---|---|
| (nm) | (Percentage) |
| 0 | 0 |
| 0.5 | 0 |
| 1 | 0 |
| 1.5 | 1 |
| 2 | 5.5 |
| 2.5 | 11 |
| 3 | 10 |
| 3.5 | 12 |
| 4 | 12 |
| 4.5 | 9 |
| 5 | 6 |
| 5.5 | 5.5 |
| 6 | 7 |
| 6.5 | 4.5 |
| 7 | 5.5 |
| 7.5 | 3 |
| 8 | 3 |
| 8.5 | 1 |
| 9 | 2 |
| 9.5 | 2 |
| 10 | 0 |

The key factors that produce the desirable conditions for the precipitation of silver oxide particles in the desired size, structure and shape include the concentration of the silver salt solution, the concentration of the precipitating agent, the concentration of desegregating agent, the rate of addition of the precipitating agent, the maintenance of a specific pH of the reaction solution and carrying out the reaction at the room temperature. An ideal combination of these factors is not predictable and prior art does not teach a suitable combination of these factors or even suggests these are critical factors in the manufacture of nano silver oxide particles.

In a typical manufacturing exercise, the precipitating agent, sodium hydroxide solution 5% w/v, is added slowly to the silver salt solution, which is kept at room temperature (25-30° C.) and stirred gently and continuously; the precipitating agent is added at a rate of 2-10 mL/min or at such suitable rate so as to maintain the pH of the slurry thus formed at 12 to 14. Since the rate of addition of the precipitating agent is critical, the use of highly accurate pumps such as liquid chromatography pumps is required. The process of precipitation is continued for as long as it is necessary to complete the reaction wherein the content of silver oxide is in excess of 97% with essentially no free ionic silver present in the precipitate. The habit of crystals appearing should be monoclinic and or tetragonal. The precipitated silver is then washed with water several times to complete the process of manufacture of nano silver oxide particles. The addition of a surfactant to the reaction mixture is intended to create conditions for the specific phase and geometry of particles as the particles are kept desegregated during the process of nucleation.

The method described above is also suitable to manufacture nano particles of other metals such as copper, platinum, lanthanum, palladium, nickel, zinc, or titanium.

The nano silver oxide particles manufacture according to the method above can then be used in a suitable carrier such as a gel, solution, slurry, etc., for a variety of applications. The suggested applications of the reported invention include a composition wherein the nano silver oxide particles are mixed with petroleum jelly in a 1:1 ratio to treat certain human and animal ailments and in particular stopping the hemorrhage in accidental injuries and wounds of all kinds where it can be used in a bandage form or for the purpose of cauterization of arteries and veins in a surgical procedure. At a concentration of 5-50 ppm of silver oxide particles in water, it can be used to kill or disable bacterial cultures and viruses contained in water supplies, and for protecting and preserving fruits and vegetables. In another application, a nano silver oxide-water colloidal mixture can be used to eradicate fungi infestation in the crops in agriculture fields. In general, particle sizes from 1-150 nm can be used for the uses described above. Since the method of manufacture describe above readily provides particles which are uniformly smaller in size, the effectiveness of the product of manufacture as described above will yield much better utility in the applications described above.

The silver oxide particles of the present invention can be used in combination with other compounds to enhance their efficacy. For examples the activity of iodine or hydrogen peroxide can be increased substantially against pathogenic organisms if nano silver particles are added to the composition. In many instances a concomitant use of nano silver oxide particles would reduce the dose of concentration required of potent, yet toxic agents like antibiotics and thus adding to the safety of various compositions intended for human or animal use. Examples of possible additive uses of the invention include combination with potassium or sodium fluoride peroxyhydride, which are known disinfecting agent. The combination results in an unexpected synergism wherein much lower quantity of these known disinfectants is required, not exceeding the range of about 1 to 5% by weight. Similarly, addition of nano silver particles to water in the presence of performic acid preferably at 1-3% by weight range provide unexpected potent antimicrobial effect. Another example of an additive that works favorably with silver/water composition (preferably 0.5-10 ppm) of the present invention is the combination with bismuth complex of 2-mercapoethanol, which is a known antibacterial agent. In another application, silver nano particles are dispersed in chelating agents to form a gel type material such as in the reaction of pentasodium diethylenetriaminepentaacetate with silver nano particles. This gel type material can be used for cleaning the hands, as this forms a protective layer on the skin; additionally, the invention protects the tissues surroundings the wound and thus obviates desiccation of wounds. The Ag-DTPA gel has a vast application in processing industries such as soap, detergents.

1. A process for the manufacturing of silver oxide nano particles, which comprises:
making a mixture of a silver salt solution with a desegregating agent Armine-Z;
adjusting maintaining the pH of said mixture to between 12-14;
combining said mixture with a solution of a precipitating agent at a rate of 2-10 mL/min of each solution.

2. The process of claim 1 wherein said silver salt is silver nitrate.

3. The process of claim 1 wherein the said desegregating agent is used is in the range of 0.01-1%.

4. The process of claim 1, wherein the said precipitating agent is sodium hydroxide, sodium carbonate or combinations thereof.

5. The process of claim 1, wherein the concentration of the said precipitating agent is 1-5% w/v in water.

6. The process of claim 1, wherein the said silver oxide nano particles have diameter in the range of 1-100 nm.
